(19) United States
(12) Patent Application Publication
(10) Pub. No.: US 2014/0075522 A1
(43) Pub. Date: Mar. 13, 2014

(54) RELIABLE VERIFICATION OF HYPERVISOR INTEGRITY

(71) Applicants: Eric L. Paris, Raleigh, NC (US); Paul Moore, Manchester, NH (US)

(72) Inventors: Eric L. Paris, Raleigh, NC (US); Paul Moore, Manchester, NH (US)

(73) Assignee: RED HAT, INC., Raleigh, NC (US)

(21) Appl. No.: 13/607,355

(22) Filed: Sep. 7, 2012

(51) Int. Cl. G06F 21/00

(52) U.S. Cl. 726/5

(57) ABSTRACT

A virtual trusted platform module (VTPM) requests a security state from a virtual machine manager. The security state is indicative of the integrity of at least a portion of software and hardware configurations of the virtual machine manager. The VTPM then receives, from the virtual machine manager, a signed security state comprising trusted platform credentials, and communicates the security state with the authentication server. The VTPM also, based on a secret received from the authentication server, initializes a process using the secret.

### TECHNICAL FIELD

The embodiments of the disclosure relate generally to virtual machine systems and, more specifically, relate to trusted computing of virtual machines.

### BACKGROUND

In computer science, a virtual machine (VM) is a portion of software that, when executed on appropriate hardware, creates an environment allowing the virtualization of an actual physical computer system. Each VM may function as a self-contained platform, running its own operating system (OS) and software applications (processes). Typically, a virtual machine manager (VMM) manages allocation and virtualization of computer resources and performs context switching, as may be necessary, to cycle between various VMs.

A host machine (e.g., computer or server) is typically enabled to simultaneously run multiple VMs, where each VM may be used by a remote client. The host machine allocates a certain amount of the host's resources to each of the VMs. Each VM is then able to use the allocated resources to execute applications, including operating systems known as guest operating systems. The VMM virtualizes the underlying hardware of the host machine or emulates hardware devices, making the use of the VM transparent to the guest operating system or the remote client that uses the VM.

However, there is no mechanism for a guest operating system of a VM to reliably determine if the VMM or hypervisor has been compromised. The hypervisor has complete control over the VM, and therefore, a malicious hypervisor may spoof computing resources and/or intercept communications of the VM.

### BRIEF DESCRIPTION OF THE DRAWINGS

Embodiments of the present disclosure are illustrated by way of example, and not by way of limitation, and can be more fully understood with reference to the following detailed description when considered in connection with the figures in which:

FIG. 1 illustrates one embodiment of a host server device which employs a virtual-machine manager (VMM) to provide virtual computing resources to one or more virtual machines;

FIG. 2 is a flow diagram of one embodiment of a method of generating TP credentials;

FIG. 3 is a flow diagram of one embodiment of a method of reliably authenticating the security state of the VMM;

FIG. 4 is a flow diagram of another embodiment of a method of reliably authenticating the security state of the VMM; and

FIG. 5 is a diagram of one embodiment of a computer system for facilitating the execution of a virtual trusted platform module.

### DETAILED DESCRIPTION

Described herein are methods and systems for reliably verifying the security state of a hypervisor or virtual machine manager. Embodiments of the present disclosure provide a virtual trusted platform module that communicates with a third-party authentication server to verify that the hypervisor or virtual machine manager has not been corrupted or otherwise modified. Due to the nature of the virtual machine manager relationship with the virtual machines depending therefrom, the virtual machine manager, if corrupted, may maliciously intercept or otherwise alter any data stream originating from or transmitting to a virtual machine.

Embodiments of the present disclosure allow the virtual machine to verify that the virtual machine manager is not modified or corrupted by requesting a security state from the virtual machine manager, receiving a signed security state from the virtual machine manager, communicating the signed security state with the authentication server, receiving a valid secret if the authentication server identifies that the security state is trusted, and initializing a process using the valid secret.

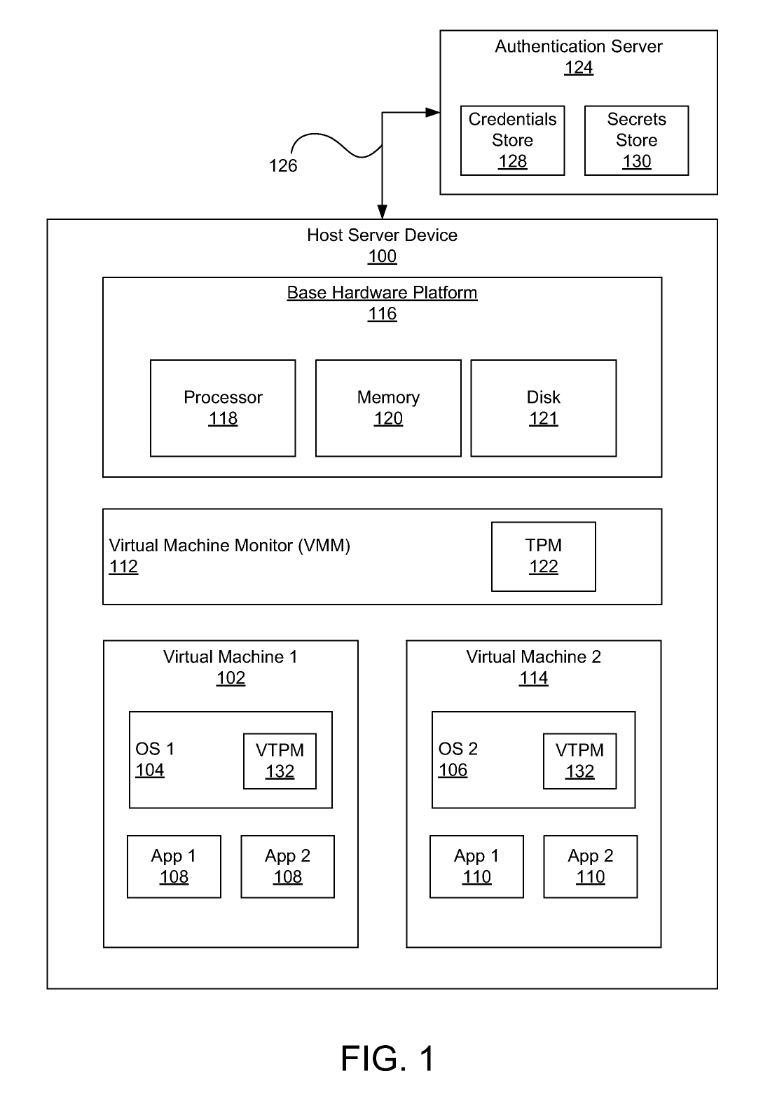

FIG. 1 illustrates one embodiment of a VM host server device 100, which employs a virtual-machine manager (VMM) 112 to provide virtual computing resources to one or more virtual machines (VMs) 102, 114. As illustrated, base platform hardware 116 comprises a computing platform, which may be capable, for example, of executing an operating system (OS) or a virtual-machine manager (VMM), such as VMM 112. In some embodiments, base hardware platform 116 may include a processor 118, memory devices 120, disk 121, network devices, drivers, and so on. VMM 112 virtualizes the physical resources of the base hardware platform 116 for one or more VMs 102, 114 that are hosted by the server device 100 having the base hardware platform 116. In some embodiments, VMM 112 may also be referred to as a hypervisor, a kernel-based hypervisor (e.g., Kernel-based VM (KVM)), or a host OS.

In one embodiment, each VM 102, 114 includes a guest operating system (OS), such as guest OS 104 or 106, and various guest software applications 108-110. Each VM 102, 114 may be configured for a different role or purpose, including, for example, to process email, credit card transactions, file storage, etc. A guest OS 104, 106 may be of the same or different type with respect to the host OS (e.g., VMM 112). For example, a guest OS may be a Windows® operating system from Microsoft® Corporation of Redmond, Wash. The VMM 112 may be of a LINUX® operating system available from Red Hat, Inc. of Raleigh, N.C. A virtual machine can be any type of virtual machine, such as, for example, hardware emulation, full virtualization, para-virtualization, and operating system-level virtualization virtual machines. Different virtual machines hosted by a server may have the same or different privilege levels for accessing different resources.

The VMM 112, in one embodiment, includes a trusted platform module (TPM) 122. A TPM 122 provides computer identity and secure services related to transactions, licensing of application and media, protecting user data, and the like. In some embodiments, the TPM 122 is configured to determine a security state of a device, and/or authenticate a user and/or a computing device (e.g., VM 102, VMM 112) on a network. Throughout this disclosure, a TPM 122 collectively represents any kind of trusted platform module, including a mobile TPM, where a TPM can be implemented using software, firmware, hardware, or a combination thereof. In one embodiment, the trusted platform module is implemented in accordance with a trusted platform module specification set forth by a trusted computing group (TCG) standard body.

The TPM 122 maintains credentials (e.g., TP credentials) that may be generated by measuring or capturing integrity of certain software and/or hardware installed in the client machine, and by analyzing changes to the software and/or hardware. Examples of integrity data include, but are not limited to, a variable number of metrics which uniquely identify certain measured objects (e.g., hash sums of files or data maintained by a software or hardware component, etc.). The measurements of the objects may be signed by a private key, which may be stored in the TPM 122. In one embodiment, the TPM 122 generates or captures the integrity data during boot time of the VMM 112. In another embodiment, the TPM 122 generates or captures the integrity data during an initialization process or dynamically at runtime of an application.

Measurement data describe properties and characteristics of the measured components (e.g., hardware and/or software components). The TPM 122 may be implemented in software, firmware, hardware, or a combination thereof. For example, the TPM 122 may be implemented entirely as software and executed in the memory 120. The secure keys and other confidential information associated with the TPM 122 may be stored in a secure storage location (e.g., of the disk 121).

The TPM 122 offers facilities for the secure generation of cryptographic keys in addition to a hardware pseudo-random number generator. The VMM 112, in one embodiment, is configured to communicate integrity data with an authentication server 124 to enable what is known as “remote attestation.” The authentication server 124 may be a separate machine including, but not limited to, a server computer, a desktop computer, a portable computing device, etc. Remote attestation creates a nearly unforgeable hash key summary of the hardware and software configuration of the host server device 100. This allows an authentication server 124 to verify that the VMM 112 has not been changed or compromised, and therefore, the VMM 112 may be trusted. The TPM 122 may be used to authenticate the hardware and software of the host server device 100 because the TPM 122, in one embodiment, contains a unique and secret RSA key burned in when the TPM 122 is produced. Trust is the expectation that a device will behave in a particular manner for a specific purpose. A trusted platform may provide at least one of basic features including, but not limited to, attestation, protected capabilities, integrity measurement, and integrity reporting. Attestation allows changes to a system to be detected by authorized parties. For example, software companies can identify unauthorized changes to software, including users tampering with software to circumvent technological protection measures. Briefly, attestation works by having the TPM 122 generate a certificate stating what software is currently running. The system can then present this certificate to authentication server 124 to show that unaltered software is currently executing. Protected capabilities refer to a set of commands with exclusive permission to access shielded locations of the TPM 122. Integrity measurement refers to, in one embodiment, the process of obtaining metrics of platform characteristics that affect the integrity (trustworthiness) of a platform, and putting digests of those metrics in shielded locations (platform configuration registers). Integrity reporting refers to the process of attesting to the contents of the shielded locations.

The authentication server 124 is configured to attest to the legitimacy of computing devices, such as the host server device 100. The authentication server 124, in one embodiment, is coupled to a network 126. The network 126 includes but is not limited to, local area networks (LAN) or wide area networks (WAN), each of which may be wired or wireless. The authentication server 124 includes a credentials store 128 and a secrets store 130. The authentication 124 receives TP credentials from various computing devices (e.g., host server device 100) and maintains the TP credentials in the credentials store 128. As described above, the TPM 122 generates a TP credential upon initialization (e.g., bootup) and communicates the TP credential with the authentication server 124. The authentication server is configured to compare received TP credentials with known valid TP credentials. For example, each time the host server device 100 is initialized, the TPM 122 calculates a new TP credential and communicates this new TP credential with the authentication server 124. If no change has been made to the host server device 100, then the new TP credential will match the TP credential stored in the credentials store 128 that corresponds to a known “trusted state” for the host server device 100. A match indicates the host server device 100 and/or the VMM 112 is “trusted,” and conversely, a non-match indicates the host server device 100 and/or the VMM 112 is no longer “trusted.”

In one embodiment, each VM 102, 114 includes a virtual TPM (VTPM) 132. Each VM 102, 114 may be configured with an instance of a VTPM 132 which may be, in one example, spawned from the TPM 122 of the VMM 112. Alternatively, each VTPM 132 may be based on a base VTPM (not shown). Each VTPM 132 maintains, in one embodiment, the TP credentials of the VM 102, 114, upon which the VTPM 132 runs. As such, each VM 102, 114 may be authenticated by the authentication server 124 by communicating TP credentials with the authentication server. The VTPM 132 is configured to generate TP credentials in a manner similar to that described above with respect to the TPM 122. In other words, the VTPM 132 may be configured to, upon initialization of the VM, measure objects to determine or capture integrity of certain software and/or virtual hardware installed in the VM 102, 114.

Each VM 102, 114 is configured to operate in a role that may be disabled until a secret is retrieved from the secrets store 130 of the authentication server. As used herein, the term “secret” refers to an object or piece of information that enables operation of a VM. Examples of secrets include, but are not limited to, cryptographic keys for IPSEC VPN, keys for decrypting a virtual disk, keys for decrypting a database, keys for enabling the startup of an application, etc. For example, the VM 114 may be configured to communicate over the network 126 to a remote server (not shown) using an Internet Protocol Security (“IPSEC”) communication channel. To initiate that IPSEC channel, the VM 114 is configured to retrieve a cryptographic key that enables communication with the remote server. The authentication server 124, in one embodiment, is configured to only return a valid cryptographic key to the VM 114 if the VMM 112 has been properly attested. In other words, if the TPM 122 communicated valid TP credentials to the authentication server 125 upon initialization, the authentication server 124 will attest to the VM 114 that the VMM 112 may be trusted, and consequently, the authentication server 124 returns a valid cryptographic key from the secrets store 130.

In one embodiment, the VTPM 132 is configured to query the VMM 112 regarding the security state of the VMM 112. The VMM 112 returns the signed query which the VTPM 132 then communicates signed query, or call, to the authentication server 124. The authentication server 124 compares the signed query with the corresponding TP credentials stored in the credentials store 128. If the signed query matches the TP credentials corresponding to the VMM 112 in the credentials store 128, the authentication server 124 attests to the VTPM 132 that the VMM 112 may be trusted. Subsequently, the authentication server 124 communicates with the VTPM 132 the secret associated with the VM 102, 114 from which the VTPM 132 originates. In one embodiment, the VTPM 132 unlocks or enables the function/process/application running on the VM 102, 114 that corresponds with the secret.

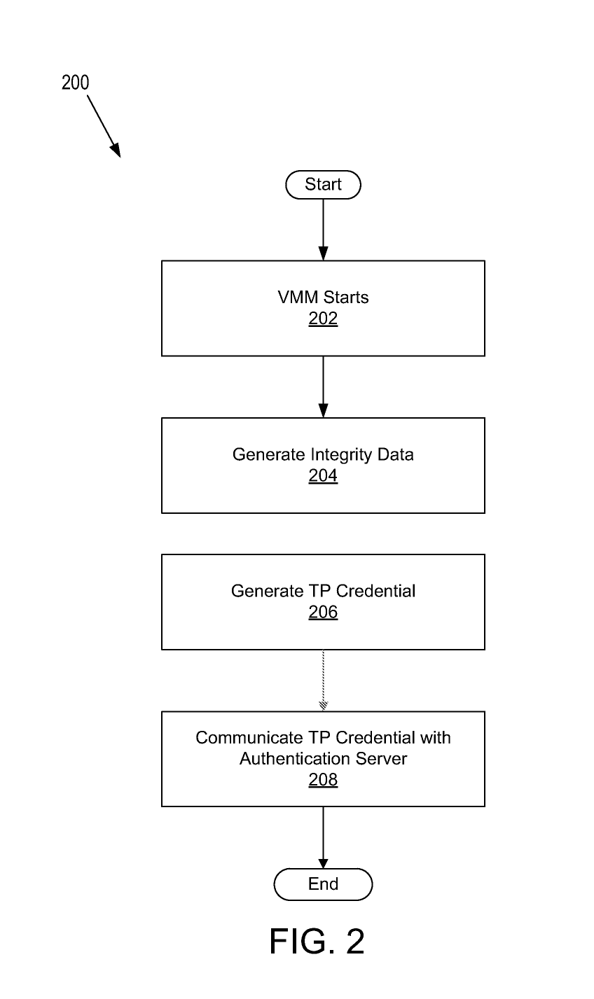

FIG. 2 is a flow diagram of one embodiment of a method 200 of generating TP credentials. The method 200 is performed by processing logic that may comprise hardware (circuitry, dedicated logic, etc.), software (such as is run on a general-purpose computing system or a dedicated machine), or a combination of both. In one embodiment, the TPM 122 of FIG. 1 performs the method 200. Alternatively, other components of the host server device 100 can be configured to perform some or all of the method 200.

The method 200 starts and the processing logic, at block 202, initializes the VMM. In one embodiment, the processing logic initializes the VMM by booting the operating system. The processing logic, during initialization, generates or captures integrity data at block 204. Examples of integrity data include, but are not limited to, a variable number of metrics which uniquely identify certain measured objects (e.g., hash sums of files or data, etc.).

From the integrity data, the processing logic generates a TP credential at block 206. Examples of TP credentials include, but are not limited to, endorsement credentials, conformance credentials, platform credentials, validation credentials, and identity credentials. In one embodiment, the processing logic generates or captures the integrity data during boot time of the VMM 112. In another embodiment, the processing logic generates or captures the integrity data during an initialization process or dynamically at runtime of an application. The processing logic, at block 208, communicates the TP credential with the authentication server 124 of FIG. 1, and the method 200 ends.

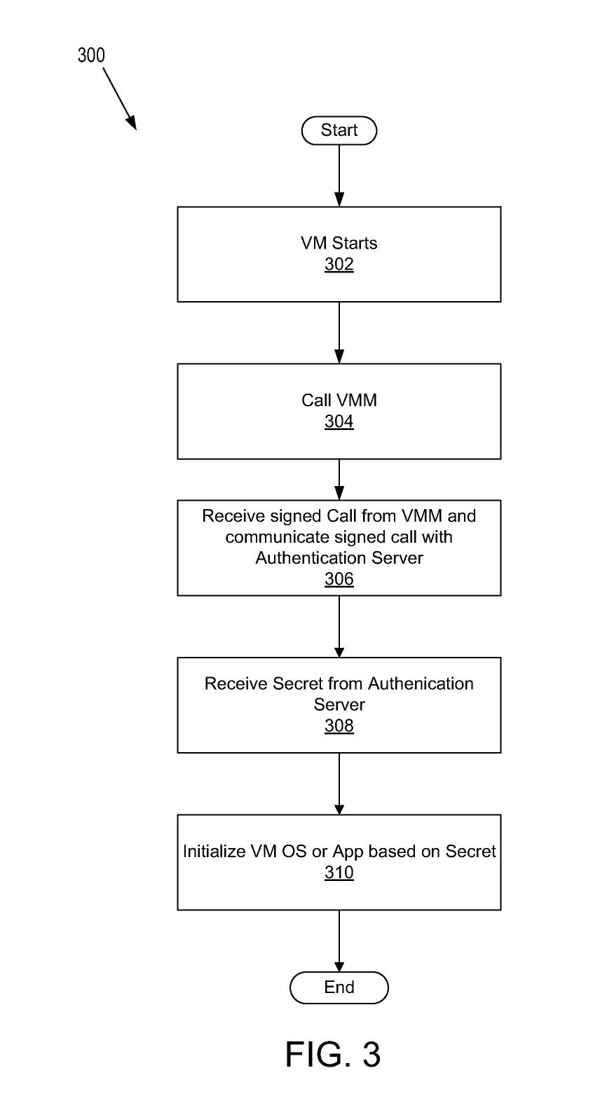

FIG. 3 is a flow diagram of one embodiment of a method 300 of reliably authenticating the security state of the VMM. The method 300 is performed by processing logic that may comprise hardware (circuitry, dedicated logic, etc.), software (such as is run on a general-purpose computing system or a dedicated machine), or a combination of both. In one embodiment, the VTPM 132 of FIG. 1 performs the method 300. Alternatively, other components of the host server device 100 can be configured to perform some or all of the method 300.

The method 300 begins and the processing logic, at block 302, initializes a VM. The processing logic, at block 304, sends a query, or call, to the VMM 112 to retrieve the security state of the VMM. Upon receiving the signed query, the processing logic, at block 306, communicates the signed query with the authentication server. For example, the processing logic may transmit the signed query over the network (e.g., local area network or wide area network) as described above with reference to FIG. 1. The processing logic, at block 308, receives a secret from the authentication server. Examples of secrets include, but are not limited to, cryptographic keys for IPSEC VPN, keys for decrypting a virtual disk, keys for decrypting a database, keys for enabling the startup of an application, etc. The processing logic, at block 310, then initializes the process associated with the secret. For example, the processing logic may use the secret to establish an IPSEC VPN tunnel, decrypt a virtual disk, decrypt a database, initialize an application or operating system, etc.

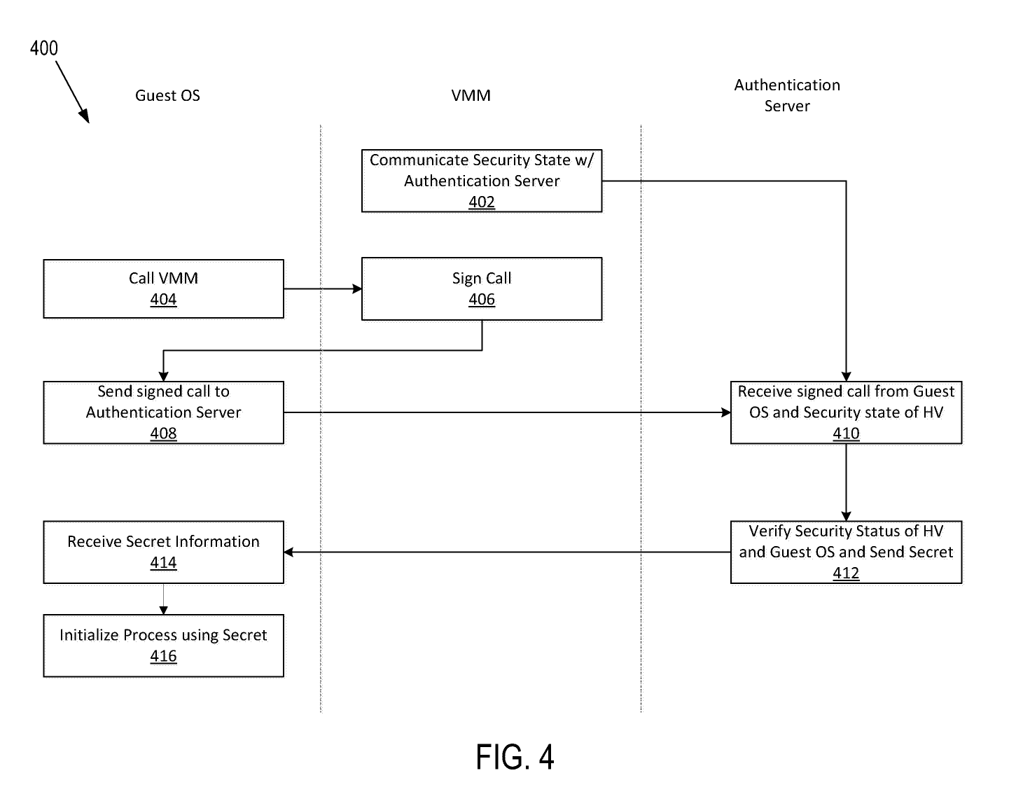

FIG. 4 is a flow diagram of another embodiment of a method 400 of reliably authenticating the security state of the VMM. The method 400 begins and the TPM, at block 402, communicates the security state of the VMM or host server device with the authentication server. In one embodiment, the TPM determines the security state (e.g., the TP credential) of the VMM by measuring or capturing integrity data of software and/or hardware installed in the VMM. Examples of integrity data include, but are not limited to, a variable number of metrics which uniquely identify certain measured objects (e.g., hash sums of files or data, etc.). Examples of TP credentials include, but are not limited to, endorsement credentials, conformance credentials, platform credentials, validation credentials, and identity credentials. The measurements of the objects may be signed by a private key, which may be stored in the TPM 122. In one embodiment, the TPM generates or captures the integrity data during boot time of the VMM 112. In another embodiment, the TPM generates or captures the integrity data during an initialization process or dynamically at runtime of an application, for example, an operating system, a hypervisor, or an application executing in the operating system or hypervisor. The TPM then stores the security state of the VMM in the credentials store 128.

The VTPM, at block 404, generates a call or query to the VMM to request the security state of the VMM. The TPM, at block 406, signs the call and returns the signed query to the guest OS. The guest OS, at block 408 communicates the signed query to the authentication server.

At block 410, the authentication server receives the signed query from the guest OS (e.g., VM 102, 114 of FIG. 1), and compares the signed call to a known, trusted, security state of the VMM. A match of the signed call to a known, trusted security state of the VMM, as maintained in the credentials store 128, indicates that the VMM has not been modified and may be trusted. The authentication server, at block 412, verifies the security status and if a match is found, returns a valid secret that corresponds to the VM 102, 114 that originated the signed call. If the authentication server is not able to match the signed call, then the authentication server may send a null response, or any invalid secret.

At block 414, the guest OS receives the secret and, at block 416, initializes a process using the secret. As described previously, the process may comprise an application, service, and/or operating system. The secret may be a cryptographic key that enables the process to initialize, establish a secure connection to another computing device, or decrypt an encrypted file, disk, database, etc.

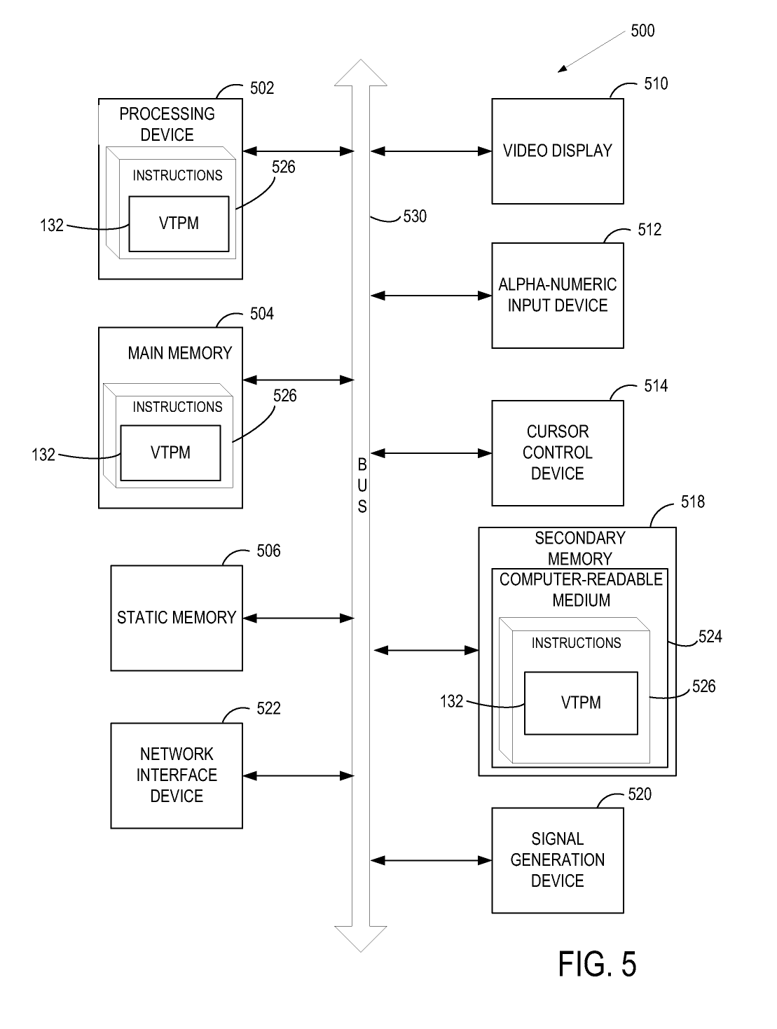

FIG. 5 is a diagram of one embodiment of a computer system for facilitating the execution of a virtual trusted platform module. Within the computer system 500 is a set of instructions for causing the machine to perform any one or more of the methodologies discussed herein. In alternative embodiments, the machine may be connected (e.g., networked) to other machines in a LAN, an intranet, an extranet, or the Internet. The machine can be a host in a cloud, a cloud provider system, a cloud controller or any other machine. The machine can operate in the capacity of a server or a client machine in a client-server network environment, or as a peer machine in a peer-to-peer (or distributed) network environment. The machine may be a personal computer (PC), a tablet PC, a console device or set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The example computer system 500 includes a processing device 502, a main memory 504 (e.g., read-only memory (ROM), flash memory, dynamic random access memory (DRAM) such as synchronous DRAM (SDRAM) or DRAM (RDRAM), etc.), a static memory 506 (e.g., flash memory, static random access memory (SRAM), etc.), and a secondary memory 518 (e.g., a data storage device in the form of a drive unit, which may include fixed or removable computer-readable storage medium), which communicate with each other via a bus 530.

Processing device 502 represents one or more general-purpose processing devices such as a microprocessor, central processing unit, or the like. More particularly, the processing device 502 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 502 may also be one or more special-purpose processing devices such as an application specific integrated circuit (ASIC), a field programmable gate array (FPGA), a digital signal processor (DSP), network processor, or the like. Processing device 502 is configured to execute the instructions 526 for performing the operations and steps discussed herein.

The computer system 500 may further include a network interface device 522. The computer system 500 also may include a video display unit 510 (e.g., a liquid crystal display (LCD) or a cathode ray tube (CRT)) connected to the computer system through a graphics port and graphics chipset, an alphanumeric input device 512 (e.g., a keyboard), a cursor control device 514 (e.g., a mouse), and a signal generation device 520 (e.g., a speaker).

The secondary memory 518 may include a machine-readable storage medium (or more specifically a computer-readable storage medium) 524 on which is stored one or more sets of instructions 526 embodying any one or more of the methodologies or functions described herein. In one embodiment, the instructions 526 include instructions for the VTPM 132. The instructions 526 may also reside, completely or at least partially, within the main memory 504 and/or within the processing device 502 during execution thereof by the computer system 500, the main memory 504 and the processing device 502 also constituting machine-readable storage media.

The computer-readable storage medium 524 may also be used to store the instructions 526 persistently. While the computer-readable storage medium 524 is shown in an example embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing or encoding a set of instructions for execution by the machine and that cause the machine to perform any one or more of the methodologies of the present invention. The term “computer-readable storage medium” shall accordingly be taken to include, but not be limited to, solid-state memories, and optical and magnetic media.

The instructions 526, components and other features described herein can be implemented as discrete hardware components or integrated in the functionality of hardware components such as ASICS, FPGAs, DSPs or similar devices. In addition, the instructions 526 can be implemented as firmware or functional circuitry within hardware devices. Further, the instructions 526 can be implemented in any combination hardware devices and software components.

In the above description, numerous details are set forth. It will be apparent, however, to one skilled in the art, that the present invention may be practiced without these specific details. In some instances, well-known structures and devices are shown in block diagram form, rather than in detail, in order to avoid obscuring the present invention.

Some portions of the detailed description which follows are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “providing,” “generating,” “capturing,” “calculating,” “encrypting,” “decrypting,” “communicating,” “receiving,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

In the following description, numerous details are set forth. It will be apparent, however, to one skilled in the art, that the present invention may be practiced without these specific details. In some instances, well-known structures and devices are shown in block diagram form, rather than in detail, in order to avoid obscuring the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as ““providing,” “generating,” “capturing,” “calculating,” “encrypting,” “decrypting,” “communicating,” “receiving,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The present invention may be provided as a computer program product, or software, that may include a machine-readable medium having stored thereon instructions, which may be used to program a computer system (or other electronic devices) to perform a process according to the present invention. A machine-readable medium includes any mechanism for storing or transmitting information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

Reference in the description to “one embodiment” or “an embodiment” means that a particular feature, structure, or characteristic described in connection with the embodiment is included in at least one embodiment of the invention. The phrase “in one embodiment” located in various places in this description does not necessarily refer to the same embodiment. Like reference numbers signify like elements throughout the description of the figures.

It is to be understood that the above description is intended to be illustrative, and not restrictive. Many other embodiments will be apparent to those of skill in the art upon reading and understanding the above description. Although the present invention has been described with reference to specific example embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense. The scope of the invention should, therefore, be determined with reference to the appended claims, along with the full scope of equivalents to which such claims are entitled.

1. A method comprising:
requesting, by a virtual machine (VM) executed by a processing device of a host server, a security state from a virtual machine manager of the host server, the security state representative of integrity of at least a portion of configurations of the virtual machine manager;
receiving, by the VM from a trusted platform module of the virtual machine manager in view of the requesting the security state, a signed security state comprising trusted platform credentials;
communicating, by the VM, the security state comprising the trusted platform credentials with an authentication server;
receiving, by the VM from the authentication server, a secret in view of the security state; and
initializing, by the VM, a process using the secret.

2. The method of claim 1, wherein the trusted platform module is implemented in accordance with a trusted platform module specification set forth by a trusted computing group (TCG) standard body.

3. The method of claim 1, wherein the secret comprises a cryptographic key for enabling the process to one of initialize an application, establish a secure communication tunnel, or decrypt an object.

4. The method of claim 1, wherein the trusted platform credentials comprise hash sums of operating system files of the host server.

5. The method of claim 1, wherein the trusted platform module is to generate the trusted platform credentials by analyzing hardware changes in a computing device.

6. The method of claim 1, wherein the authentication server further comprises a credentials store for maintaining trusted platform credentials of a plurality of computing devices.

7. The method of claim 1, wherein the authentication server further comprises a secret store for maintaining secrets of a plurality of virtual machines.

8. The method of claim 1, wherein the security state comprises a TP credential, the TP credential comprising at least one of an endorsement credential, a conformance credential, a platform credential, a validation credential, and an identity credential.

9. A non-transitory computer readable storage medium including instructions that, when executed by a processing device, cause the processing device to perform operations comprising:
requesting, by a virtual machine (VM) executed by the processing device of a host server, a security state from a virtual machine manager of the host server, the security state representative of integrity of at least a portion of configurations of the virtual machine manager;
receiving, by the VM from a trusted platform module of the virtual machine manager in view of the requesting the security state, a signed security state comprising trusted platform credentials;
communicating, by the VM, the security state comprising the trusted platform credentials with an authentication server;
receiving, by the VM from the authentication server, a secret in view of the security state; and
initializing, by the VM, a process using the secret.

10. The non-transitory computer readable storage medium of claim 9, wherein the trusted platform module is implemented in accordance with a trusted platform module specification set forth by a trusted computing group (TCG) standard body.

11. The non-transitory computer readable storage medium of claim 9, wherein the secret comprises a cryptographic key for enabling the process to one of initialize an application, establish a secure communication tunnel, or decrypt an object.

12. The non-transitory computer readable storage medium of claim 9, wherein the trusted platform credentials comprise hash sums of operating system files of the host server.

13. The non-transitory computer readable storage medium of claim 9, wherein the trusted platform module is to generate the trusted platform credentials by analyzing hardware changes in a computing device.

14. The non-transitory computer readable storage medium of claim 9, wherein the authentication server further comprises a credentials store for maintaining trusted platform credentials of a plurality of computing devices.

15. The non-transitory computer readable storage medium of claim 9, wherein the authentication server further comprises a secret store for maintaining secrets of a plurality of virtual machines.

16. A computing apparatus comprising:
a memory to store instructions for providing a virtual trusted platform module;
a processing device communicably coupled to the memory; and
a virtual machine manager to virtualize the processing device and the memory for use by a virtual machine (VM) executable from the memory by the processing device, the VM to:
request a security state from the virtual machine manager, the security state representative of integrity of at least a portion of configurations of the virtual machine manager;
receive, from the virtual trusted platform module of the virtual machine manager in view of the requesting the security state, a signed security state comprising trusted platform credentials;
communicate the security state comprising the trusted platform credentials with an authentication server;
receive, from the authentication server, a secret in view of the security state; and
initialize a process using the secret.

17. The computing apparatus of claim 16, wherein the virtual trusted platform module is implemented in accordance with a trusted platform module specification set forth by a trusted computing group (TCG) standard body.

18. The computing apparatus of claim 16, wherein the secret comprises a cryptographic key for enabling the process to one of initialize an application, establish a secure communication tunnel, or decrypt an object.

19. The computing apparatus of claim 16, wherein the authentication server further comprises a credentials store for maintaining trusted platform credentials of a plurality of computing devices.

20. The computing apparatus of claim 16, wherein the authentication server further comprises a secret store for maintaining secrets of a plurality of virtual machines.
